(19) United States
(12) Patent Application Publication
(10) Pub. No.: US 2014/0046511 A1
(43) Pub. Date: Feb. 13, 2014

(54) SYSTEM FOR CONTROLLING ENGINE INLET AIR TEMPERATURE

(71) Applicants: Teoman UZKAN, Indian Head Park, IL (US); Thomas G. GALLAGHER, Plainfield, IL (US)

(72) Inventors: Teoman UZKAN, Indian Head Park, IL (US); Thomas G. GALLAGHER, Plainfield, IL (US)

(73) Assignee: Electro-Motive Diesel, Inc.

(21) Appl. No.: 13/569,675

(22) Filed: Aug. 8, 2012

(51) Int. Cl. F02B 29/04; G06F 19/00

(52) U.S. Cl. 701/19; 123/563

(57) ABSTRACT

A system for controlling engine inlet air temperature may include a compressor configured to increase pressure of air at an engine air inlet and at least one aftercooler configured to reduce the engine inlet air temperature. The system may also include a temperature sensor configured to provide signals indicative of ambient air temperature and a pressure sensor configured to provide signals indicative of ambient air pressure. The system may include a controller configured to receive signals indicative of the ambient air temperature and the ambient air pressure and determine a desired engine inlet air temperature based on the signals indicative of the ambient air temperature and the ambient air pressure. The controller may be configured to control operation of the at least one aftercooler based on the desired engine air inlet temperature.

### TECHNICAL FIELD

This disclosure relates generally to a system and method for controlling engine inlet air temperature and, more specifically, to a system and method for controlling engine inlet air temperature in an engine including a compressor.

### BACKGROUND

Heavy-duty trucks and diesel-electric locomotives often include engines having turbochargers and aftercoolers to increase fuel efficiency and reduce mono-nitrogen oxide (“NOx”) emissions. The compressor of the turbocharger increases engine inlet air pressure and density, which increases the amount of fuel that can be burned. However, the compressor also increases the engine inlet air temperature, which decreases the air density. To counteract this temperature increase, aftercoolers may be used to lower the temperature of the air leaving the compressor. By lowering the temperature, aftercoolers are capable of decreasing both engine brake-specific fuel consumption (“BSFC”) and engine NOx emissions (brake-specific NOx emissions, or “BSNOx”). Therefore, it is desirable to cool engine air as much as practically possible. For most practical applications, the aftercooler, which may use ambient air to cool the engine inlet air, can best be expected to decrease the engine air temperature to 20-30° F. above the ambient air temperature.

When these vehicles are operated in low ambient air temperature conditions, however, the aftercooler can excessively lower the engine inlet air temperature, resulting in condensation or frost at the aftercooler outlet, which may lead to premature degradation of the engine components, such as the cylinder liners, intake manifolds, and valves or ports. When the engine inlet air becomes too cool, water condensation or even frost formation may occur in or at the outlet of the air-to-air aftercooler. However, if the engine inlet air is not cooled as much as possible without causing condensation or frost formation, the possible gains in BSFC and/or BSNOx may not be achieved.

One solution for condensation control in internal combustion engines is described in U.S. Pat. No. 6,681,171 (“the '171 patent”). The '171 patent is directed to a method for reducing or eliminating formation of exhaust gas recirculation (“EGR”) condensate that monitors current ambient and operating conditions to determine whether conditions are favorable for condensation of EGR gas and controls the engine accordingly to avoid condensation by increasing the intake manifold temperature. The intake manifold temperature may be increased by redirecting some or all of the EGR flow to avoid the EGR cooler. Some or all of the charge air may be redirected to bypass the charge air cooler and/or redirected from the outlet of the turbocharger compressor to the intake, resulting in a corresponding increase of the intake manifold temperature.

Although the system and method disclosed in the '171 patent may reduce or eliminate condensation of EGR gas, the system and method disclosed may still suffer from a number of possible drawbacks. For example, the solution provided by the '171 patent is limited to engines that incorporate EGR. Additionally, the system and method of the '171 patent does not keep the engine air inlet temperature close to the dew point temperature to maximize the possible BSFC and/or BSNOx gains from aftercooling. Furthermore, the solution proposed in the '171 patent does not present a method of regulating the operation of an aftercooler to decrease condensation or frost formation.

The presently disclosed systems and methods may mitigate or overcome one or more of the above-noted drawbacks and/or other problems in the art.

### SUMMARY

The present disclosure is directed to a system for controlling engine inlet air temperature. The system may include a compressor configured to increase pressure of air at an engine air inlet and at least one aftercooler configured to reduce the engine inlet air temperature. The system may also include a temperature sensor configured to provide signals indicative of ambient air temperature and a pressure sensor configured to provide signals indicative of ambient air pressure. The system may include a controller configured to receive signals indicative of the ambient air temperature and the ambient air pressure and determine a desired engine inlet air temperature based on the signals indicative of the ambient air temperature and the ambient air pressure. The controller may be configured to control operation of the at least one aftercooler based on the desired engine air inlet temperature.

According to another aspect, the present disclosure is directed to a method for controlling an engine inlet air temperature. The method may include receiving signals from a sensor indicative of at least one of ambient air pressure and ambient temperature and determining a desired engine inlet air temperature based on the signal received from the sensor. The method may also include controlling the engine inlet air temperature based on the desired engine inlet air temperature.

In yet another aspect, the present disclosure is directed to a locomotive. The locomotive may include a plurality of wheels and at least one traction motor configured to supply power to the plurality of wheels. The locomotive may also include an engine configured to supply power to the at least one traction motor. The locomotive may also include a system for controlling engine inlet air temperature. The system may include a compressor configured to increase pressure of air at an engine air inlet and at least one aftercooler configured to reduce the engine inlet air temperature. The system may also include a temperature sensor configured to provide signals indicative of ambient air temperature and a pressure sensor configured to provide signals indicative of ambient air pressure. The system may include a controller configured to receive signals indicative of the ambient air temperature and the ambient air pressure and determine a desired engine inlet air temperature based on the signals indicative of the ambient air temperature and the ambient air pressure. The controller may be configured to control operation of the at least one aftercooler based on the desired engine air inlet temperature.

### BRIEF DESCRIPTION OF THE DRAWINGS

FIG. 1 shows a perspective view of an exemplary embodiment of a locomotive.

FIG. 2 is a block diagram of a system for controlling engine inlet air temperature

FIG. 3 is a flow diagram depicting an exemplary embodiment of a method for controlling engine inlet air temperature.

### DETAILED DESCRIPTION

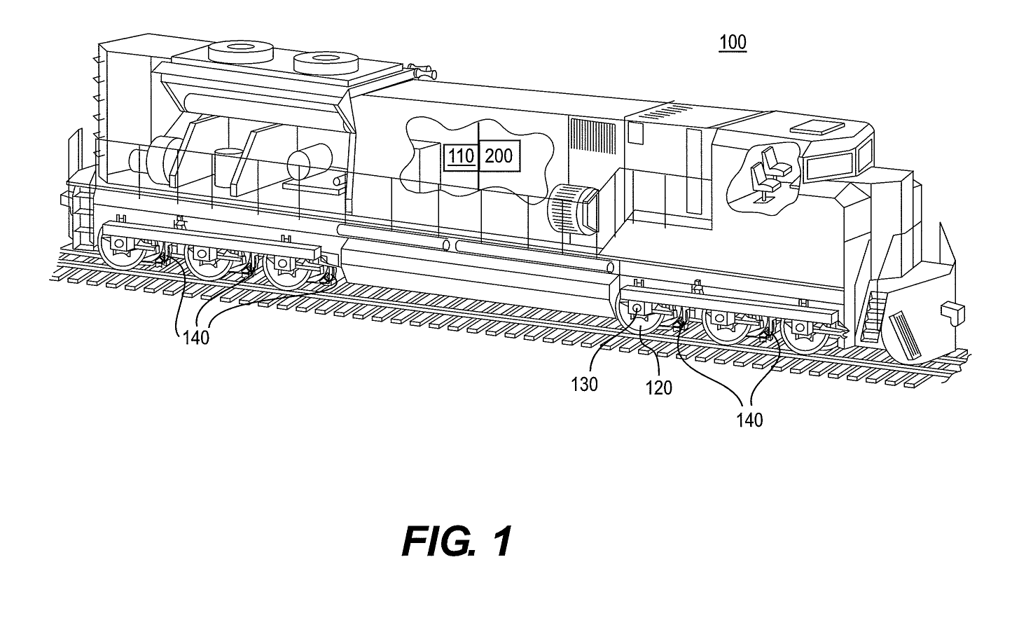

FIG. 1 shows an exemplary vehicle 100, for example, a locomotive, in which systems and methods for engine air inlet temperature control may be implemented consistent with the disclosed exemplary embodiments. Vehicle 100 may be any vehicle having an engine 110, such as, for example, a spark-ignition engine, a compression-ignition engine, or combinations thereof. For example, vehicle 100 may be any electrically powered rail vehicle employing DC traction motors for propulsion. According to the exemplary embodiment illustrated in FIG. 1, vehicle 100 may include a plurality of pairs of wheels 120, with each pair of wheels 120 connected to an axle 130 that is rotatably coupled to a traction motor 140. During powering of exemplary vehicle 100, traction motors 140 may operate to propel vehicle 100. Engine 110 may function to power vehicle 100, including traction motors 140. Vehicle 100 may include a system 200 for controlling engine air inlet temperature for use in combustion.

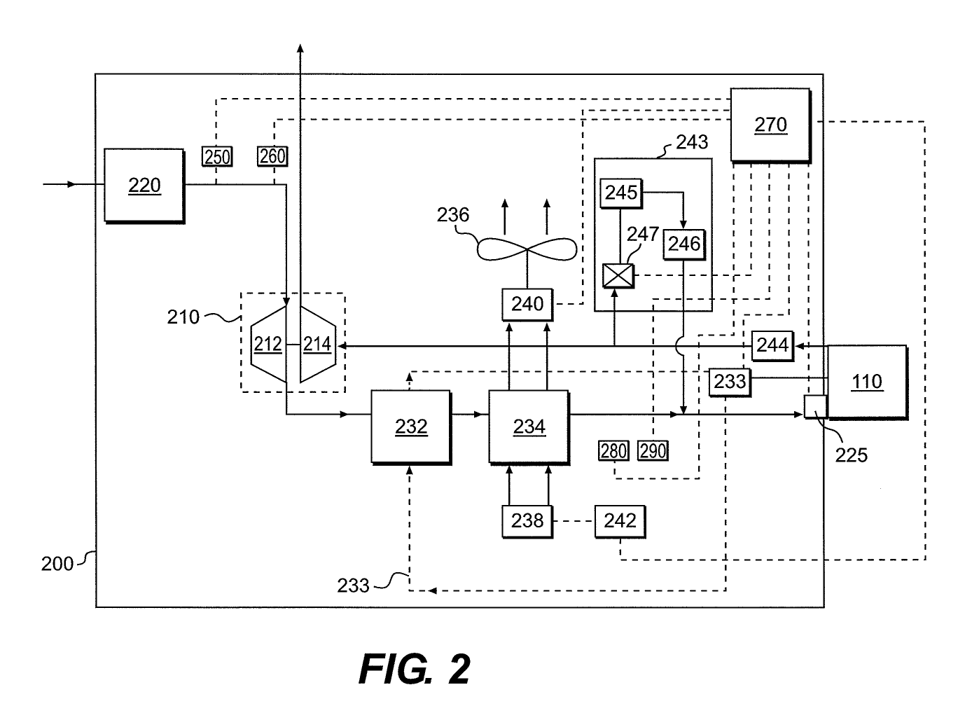

FIG. 2 is a block diagram of an exemplary embodiment of a system 200 for controlling air inlet temperature. System 200 may include a turbocharger 210 having a compressor 212 and a turbine 214 for powering compressor 212. Turbocharger 210 may increase the power density of engine 110 by compressing and increasing the amount of air supplied to engine 110 for combustion. For example, turbocharger 210 may draw ambient air from the atmosphere, which may be filtered by a filter 220 before reaching turbocharger 210. Turbocharger 210 may use compressor 212 to compress the filtered air to increase the amount of air delivered to engine 110 at an engine air inlet 225. Increasing the amount of air to engine 110 may increase the amount of fuel engine 110 may burn.

While the compressor 212 of turbocharger 210 increases the engine air pressure at engine air inlet 225, it may also increase the temperature of inlet air at engine air inlet 225. The increase of the air inlet temperature may decrease the air density at engine air inlet 225, which may have a negative effect on engine efficiency. Therefore, engine 110, which includes turbocharger 210, may also include one or more aftercoolers to cool at least a portion of the engine air that has been compressed by turbocharger 210 to a select temperature. As aftercooling may decrease both BSFC and engine NOx emissions, it may be desirable to decrease the temperature of air at engine air inlet 225 as much as practically possible.

In the exemplary embodiment shown in FIG. 2, system 200 includes an air-to-water aftercooler 232, which uses a coolant, such as water, to reduce the temperature of the air at engine air inlet 225. The heat from the inlet air may be transferred to the coolant at air-to-water aftercooler 232. A water loop controller 233 may control the supply of the coolant to air-to-water aftercooler 232. For example, coolant may be supplied from a water loop 231 associated with engine 110, and water loop controller 233 may control the supply of coolant from the water loop to air-to-water aftercooler 232. According to some embodiments, water loop 231 may include additional devices to adjust the coolant supply to air-to-water aftercooler 232. For example, water loop 231 may include a valve 229 and/or water pump 230 that water loop controller 233 may control.

Exemplary system 200 shown in FIG. 2 also includes an air-to-air aftercooler 234. For example, the air leaving air-to-water aftercooler 232 may flow through air-to-air aftercooler 234, where it is further cooled by ambient air. For example, ambient air may be forced by one or more fans 236 through shutters 238. The speed of fans 236 may be related to engine speed during normal operation and/or controlled by fan speed actuators 240, such as, for example, one or more fan motors. Fan speed actuator 240 may be configured to control the flow rate of air to air-to-air aftercooler 234. According to some embodiments, system 200 may include a shutter controller 242 configured to control the flow of ambient air to air-to-air aftercooler 234. For example, shutter controller 242 may be configured to control opening and closing of shutters 238 to regulate heat transfer based on, for example, engine operating conditions and/or the ambient air temperature (e.g., to reduce undesirable heat loss at low ambient temperatures). After the air leaves the air-to-air aftercooler 234, it may flow to engine air inlet 225 for use in combustion. The air supplied at engine air inlet 225 may be referred to as the engine inlet air.

Exemplary system 200 may optionally include an exhaust gas recirculation (EGR) system 243. EGR system 243 may recirculate a portion of exhaust gas from exhaust manifold 244 of engine 110 and mix this gas with air from air-to-water aftercooler 232 and/or air-to-air aftercooler 234. This mixture may thereafter be delivered to engine air inlet 225.

According to some embodiments, only a portion of the exhaust gas is recirculated and mixed with the air supplied to engine air inlet 225 to selectively reduce pollutant emissions, including NOx, while achieving a desired fuel efficiency. In addition the percentage of exhaust gas to be recirculated may depend on the amount of exhaust gas flow desired for powering compressor 212 of turbocharger 210. For example, it may be desired that sufficient exhaust gas is supplied to turbine 214 of turbocharger 210, such that an optimal amount of air is supplied to engine air inlet 225 of engine 110 for combustion purposes. For example, for locomotive diesel engine applications, the percentage of exhaust gas delivered to engine air inlet 225 of engine 110 by EGR system 243 may be less than about 35%. This percentage may provide for pollutant emissions to be reduced without compromising the desired fuel efficiency. In order to control the amount of exhaust gas supplied to the engine inlet air, exemplary EGR system 243 includes an EGR valve 247 configured to control the amount of exhaust gas supplied to the engine inlet air.

According to some embodiments, EGR system 243 may include an EGR cooler 245 configured to decrease the temperature of recirculated exhaust gas before it is mixed with the engine inlet air, thereby providing a more dense intake charge to engine 110. It may be preferable to have cooled exhaust gas instead of hotter exhaust gas at this point in EGR system 243 due to ease of deliverability and compatibility with downstream EGR system and engine components. According to some embodiments, EGR system 243 may include a positive flow device 246. For example, as shown in FIG. 2, from EGR cooler 246, recirculated exhaust gas may flow to a positive flow device 246, which increases the pressure of the exhaust gas to overcome the pressure loss within EGR system 243 itself. Positive flow device 246 may be in the form of a roots blower, venturi, centrifugal compressor, propeller, or any other device configured to increase the pressure of the exhaust gas. According to some embodiments, positive flow device 246 may be internally sealed such that oil does not contaminate the recirculated exhaust gas.

In the exemplary embodiment shown, system 200 may include sensors to monitor air conditions at various points within system 200. For example, system 200 may include a pressure sensor 250 configured to provide signals indicative of air pressure at a point upstream of compressor 212. In some embodiments, pressure sensor 250 may send signals indicative of the ambient air pressure at the inlet of filter 220 and/or the inlet of compressor 212. System 200 may also include a temperature sensor 260 configured to provide signals indicative of air temperature at a point upstream of compressor 212. In some embodiments, temperature sensor 260 may send signals indicative of the ambient air temperature at the inlet of filter 220 and/or the inlet of compressor 212. Additionally or alternatively, system 200 may include a sensor 265 configured to send signals indicative of at least one of an air temperature and an air pressure at the inlet of filter 220 to controller 270.

System 200 may include a controller 270 configured to receive signals indicative of the ambient air pressure and the ambient air temperature from pressure sensor 250 and temperature sensor 260. Based on these signals, controller 270 may be configured to control the temperature of the engine inlet air at engine air inlet 225. For example, controller 270 may control the temperature of the engine inlet air to prevent condensation or frost formation by preventing the temperature of the engine inlet air from falling below the dew point temperature at the pressure of the engine inlet air.

In some embodiments, controller 270 may determine a dew point temperature for the engine inlet air based on the signals received from pressure sensor 250 and temperature sensor 260 indicative of the ambient air pressure and ambient temperature, respectively, at filter 220 and/or upstream of compressor 212, or from sensor 265. From these values, controller 270 may calculate the dew point temperature of the engine inlet air. For example, the amount of water vapor and dry air in the air entering filter 220 and/or upstream of compressor 212 may be the same as the amount of water vapor and dry air at the outlet of air-to-air aftercooler 234. Therefore, the dew point temperature of the engine inlet air, for example, at the outlet of air-to-air aftercooler 234, may be determined according to known methods based on the pressure and temperature of the air at filter 220 and/or compressor 21, and the pressure and/or temperature of the air downstream of air-to-air aftercooler 234 (e.g., at engine air inlet 225). According to some embodiments, system 200 may include a humidity sensor 295 to measure the humidity of the engine inlet air and/or the pressure and temperature of the engine inlet air between air-to-air aftercooler 234 and engine air inlet 225.

According to some embodiments, controller 270 may consider additional characteristics of engine 110 to determine the dew point at engine air inlet 225. For example, controller 270 may factor in air characteristics at engine air inlet 225. System 200 may include a second pressure sensor 280 for sending signals indicative of the air pressure at engine air inlet 225. System 200 may include a second temperature sensor 290 for sending signals indicative of the air temperature at engine air inlet 225. According to some embodiments, controller 270 may determine the humidity of air at engine air inlet 225 by considering the air temperature and pressure at filter 220. Additionally or alternatively, controller 270 may determine the humidity based on signals from humidity sensor 295. Based on the temperature and pressure at engine air inlet 225, as well as the humidity at engine air inlet 225, controller 270 may use known engineering methods for determining dew point temperature based on temperature, pressure, and/or humidity.

According to some embodiments, controller 270 may be configured to calculate a desired engine inlet air temperature based on signals received from pressure sensor 250 and temperature sensor 260. For example, the desired engine inlet air temperature may be equal to or slightly above the dew point temperature between air-to-air aftercooler 234 and engine air inlet 225. In some embodiments, desired engine inlet air temperature may be based on a parameter associated with operation of engine 110. For example, the engine parameters may include the engine speed and/or the notch position. The notch position may be indicative of the amount of power that engine 110 is being supplied. For example, engine 110 may have eight discrete notches on the throttle gate, in addition to idle. In some embodiments, the engine parameters may include characteristics of compressor 212 and/or one or more of air-to-water aftercooler 232 and air-to-air aftercooler 234. The engine parameters may include other characteristics of engine 110 or its components.

In some embodiments, controller 270 may use a computer engine model to determine the desired engine inlet air temperature. The engine model may be a collection of geometric, operational, and/or boundary information for engine 110, such that when the ambient air conditions (e.g., ambient temperature and/or ambient pressures) are available, the engine model may determine the value of engine parameters, such as the power output, BSFC, BSNOx, turbocharger speed of engine 110, and/or parameters associated with operation of related components. Controller 270 may use the engine model continuously or periodically while engine 110 is operating, as the desired engine inlet air temperature may change as a result of changing environmental and/or operational variables. For example, the engine model may consider ambient air temperature, pressure, and/or humidity; engine notch position, speed, and/or fuel rate; and/or inlet air flow rate. For embodiments of engine 110 capable of EGR, the engine model may also consider EGR gas pressure, temperature, humidity, and/or flow rate, for example, measured upstream of the connection point to engine air inlet 225.

According to some embodiments, based on the properties measured by the sensors and the desired engine inlet air temperature, controller 270 may determine a desired fan speed and send a command signal to fan 236 and/or fan speed actuator 240 to achieve the desired fan speed. Fan 236 and/or fan speed actuator 240 may be configured to change the fan speed in response to the signal received from controller 270. According to some embodiments, the desired fan speed may be selected to adjust the engine inlet air temperature to within a predefined range of the desired engine inlet air temperature. For example, the predefined range may account for a margin of error associated with sensors 250 and 260 and/or controller 270.

According to some embodiments of system 200, controller 270 may control EGR valve 247 to adjust the amount of exhaust air recirculated through system 200. For example, this control may be based on properties measured by the sensors and the desired engine inlet air temperature. Controller may send a command signal to EGR valve 247 to achieve a desired percentage of recirculated exhaust gas to mix with air downstream from air-to-air aftercooler 234. According to some embodiments, the percentage of recirculated exhaust gas may be selected to adjust the engine inlet air temperature to within a predefined range of the desired engine inlet air temperature. For example, the predefined range may account for a margin of error associated with the precision of EGR valve 247 to control the exhaust gas flow.

According to some embodiments, based on the desired engine inlet air temperature and/or the sensed temperature and pressure of the engine inlet air, controller 270 may control fan 236 and/or shutters 238 to maintain the engine inlet air temperature above the desired engine inlet air temperature. Alternatively or additionally, controller 270 may control operation of EGR system 243 and/or water loop controller 233. According to some embodiments, system 200 may include additional sensors to monitor the engine inlet air. Second pressure sensor 280 configured to measure the engine inlet air pressure and to send signals indicative of the engine inlet air pressure to controller 270. Second temperature sensor 290 may send signals to controller 270 indicative of the engine inlet air temperature. Controller 270 may adjust the speed of fan 236 based on one or more of the signals received from second pressure sensor 280 and/or second temperature sensor 290. For example, if the temperature measured by second temperature sensor 290 is lower than the dew point temperature or lower than the desired engine inlet air temperature, controller 270 may decrease the speed of fan 236 to decrease the cooling effects of air-to-air aftercooler 234 on the engine inlet air. Conversely, controller 270 may increase the speed of fan 236 if engine inlet air temperature is higher than the desired engine inlet air temperature to increase the cooling capacity of air-to-air aftercooler 234, which may have a positive effect on the efficiency of engine 110.

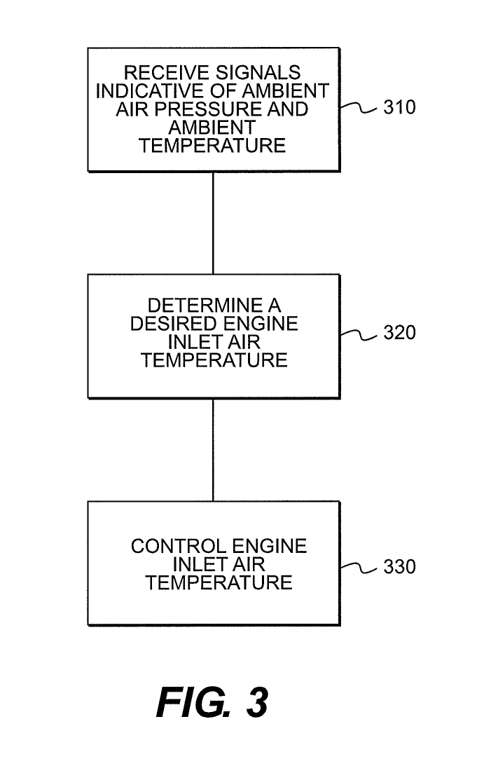

FIG. 3 is a flow diagram of an exemplary embodiment of a method of controlling an engine inlet air temperature. At step 310, controller 270 may receive signals from one or more sensors indicative of pressure and/or temperature values of ambient air entering system 200, for example, at filter 220. In some embodiments, controller 270 may receive these signals from pressure sensor 250 and temperature sensor 260.

At step 315, controller 270 may receive signals indicative of engine inlet air pressure and engine inlet air temperature. As explained above, controller 270 may use these signals to determine the dew point temperature at engine air inlet 225 using known methods based on the signals indicative of ambient air pressure and temperature. At step 320, controller 270 may determine a desired engine inlet air temperature based on the signals received from one or more sensors 250 and 260. Step 320 may include determining a dew point temperature associated with the engine inlet air. According to some embodiments, step 320 includes calculating the desired engine inlet air temperature based on a parameter associated with operation of engine 110. For example, the desired engine inlet air temperature may be based on at least one of an engine speed and a notch position.

At step 330, controller 270 may control the temperature of engine inlet air supplied to engine air inlet 225. For example, controller 270 may determine a fan speed based on the desired engine inlet air temperature. According to some embodiments, controller 270 determines the fan speed that will provide an engine inlet air temperature to within a predefined range of the desired engine inlet air temperature. For example, based on step 330, controller 270 may send a command to adjust a fan to achieve the desired fan speed.

Controller 270 may adjust other elements of system 200 to achieve the desired engine inlet air temperature. For example, controller 270 may adjust the position of shutters 238 by, for example, sending a command signal to shutter controller 242 to open and/or close shutters 238 to control the flow of ambient air to air-to-air aftercooler 234 in step 340. Additionally or alternatively, adjusting the flow of coolant from water loop supplied to air-to-water aftercooler 232 may also affect the engine inlet air temperature. Controller 270 may send a command signal to water loop controller 233 to adjust the amount of coolant supplied to air-to-water aftercooler 232 to achieve the desired engine inlet air temperature in step 340. Additionally or alternatively, controller 270 may control EGR valve 247 to adjust the amount of exhaust air recirculated through system 200 to achieve the engine inlet air temperature.

According to some embodiments, the method may further include receiving a second signal indicative of the engine inlet air temperature and/or pressure. For example, second temperature sensor 290 may send a signal to controller 270. Alternatively, or additionally, the method may include receiving a signal indicative of the engine inlet air pressure. For example, second pressure sensor 280 may send a signal to controller 270. Controller 270 may control the engine inlet air temperature based on the signals received from second temperature sensor 290 and/or second pressure sensor 280. For example, if the signal from second temperature sensor 290 indicates that the engine inlet air temperature is below the desired engine inlet air temperature, controller 270 may decrease the fan speed. Similarly, if the engine inlet air temperature is above the desired engine inlet air temperature, controller 270 may increase the fan speed to lower the engine inlet air temperature to as close to the desired engine inlet air temperature without dropping below it.

### INDUSTRIAL APPLICABILITY

The disclosed systems and methods may provide a robust solution for reducing the condensation or frost formation of water vapor present in the engine inlet air. For example, the disclosed systems and methods may increase the fuel efficiency of an engine (e.g., for a locomotive) while reducing condensation or frost formation caused by excessive cooling of engine inlet air.

The presently disclosed systems and methods may provide several advantages. For example, fuel efficiency of an engine incorporating the disclosed system and/or method may be increased. For a decrease in both BSFC and BSNOx, an engine should cool the engine inlet air as much as practically possible without inducing condensation or frost formation at the engine air inlet. For example, the disclosed systems and methods may balance the desire to reduce engine air inlet temperature with the desire to prevent excessive condensation and/or frost formation that occurs when the engine inlet air drops to or below a dew point temperature by allowing as much cooling of engine inlet air without allowing the engine inlet air temperature to drop below a desired engine inlet air temperature limit. Furthermore, the presently disclosed systems and methods may be incorporated into an engine system, regardless of whether the engine cooling system uses EGR.

It will be apparent to those skilled in the art that various modifications and variations can be made to the system for controlling engine inlet air temperature and associated methods for operating the same. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A system for controlling engine inlet air temperature, the system comprising:
a compressor configured to increase pressure of air at an engine air inlet;
at least one aftercooler configured to reduce the engine inlet air temperature;
a temperature sensor configured to provide signals indicative of ambient air temperature;
a pressure sensor configured to provide signals indicative of ambient air pressure; and
a controller configured to:
receive signals indicative of the ambient air temperature and the ambient air pressure;
determine a desired engine inlet air temperature based on the signals indicative of the ambient air temperature and the ambient air pressure; and
control operation of the at least one aftercooler based on the desired engine air inlet temperature.

2. The system of claim 1, further including:
a second temperature sensor configured to provide signals indicative of temperature at the engine air inlet; and
a second pressure sensor configured to provide signals indicative of pressure at the engine air inlet, wherein the controller is configured to determine the desired engine inlet air temperature based on a dew point temperature of the air at the engine air inlet based on the signals indicative of ambient air temperature and pressure and the signals indicative of temperature and pressure at the engine air inlet.

3. The system of claim 1, wherein the controller is configured to control operation of the at least one aftercooler such that the engine air inlet temperature is within a predefined range of the desired engine air inlet temperature.

4. The system of claim 1, wherein the at least one aftercooler includes an air-to-air aftercooler, and the controller is configured to control a flow of ambient air to the air-to-air aftercooler based on the desired engine inlet air temperature.

5. The system of claim 4, further including a fan configured to control a flow rate of ambient air to the air-to-air aftercooler, wherein the controller is configured to control a speed of the fan based on the desired engine inlet air temperature.

6. The system of claim 4, further including shutters associated with the air-to-air aftercooler and configured to control air flow to the air-to-air aftercooler, wherein the controller is configured to control operation of the shutters based on the desired engine inlet air temperature.

7. The system of claim 1, wherein the at least one aftercooler includes an air-to-water aftercooler, and wherein the controller is configured to control a flow of coolant to the air-to-water aftercooler based on the desired engine air inlet temperature.

8. The system of claim 1, further including an exhaust gas recirculation system configured to supply exhaust gas to the engine air inlet, wherein the controller is configured to control a flow of exhaust gas to the engine air inlet based on the desired engine air inlet temperature.

9. The system of claim 2, wherein the controller is configured to further control operation of the at least one aftercooler based on the signals provided by the second temperature sensor and the second pressure sensor.

10. The system of claim 1, wherein the controller is configured to calculate the desired engine inlet air temperature based on a parameter associated with operation of the engine.

11. The system of claim 10, wherein the parameter associated with operation of the engine includes at least one of an engine speed and a notch position.

12. A method for controlling an engine inlet air temperature, the method comprising:
receiving signals from a sensor indicative of at least one of ambient air pressure and ambient temperature;
determining a desired engine inlet air temperature based on the signals received from the sensor; and
controlling the engine inlet air temperature based on the desired engine inlet air temperature.

13. The method of claim 12, further including:
receiving signals from at least a second sensor indicative of temperature and pressure at the engine inlet;
determining a dew point temperature of the air at the engine air inlet based on at least one of the signals indicative of ambient air pressure, ambient temperature, temperature at the engine inlet, and pressure at the engine inlet; and
determining the desired engine inlet air temperature based on the dew point temperature of the air at the engine air inlet.

14. The method of claim 12, wherein controlling the engine inlet air temperature includes controlling flow of ambient air to an air-to-air aftercooler based on the desired engine inlet air temperature.

15. The method of claim 12, wherein controlling the engine inlet air temperature includes controlling a flow of coolant to an air-to-water aftercooler based on the desired engine inlet air temperature.

16. A locomotive comprising:
a plurality of wheels;
at least one traction motor configured to supply power to the plurality of wheels;
an engine configured to supply power to the at least one traction motor; and
a system for controlling engine inlet air temperature, the system comprising:
a compressor configured to increase pressure of air at an engine air inlet;
at least one aftercooler configured to reduce the engine inlet air temperature;
a temperature sensor configured to provide signals indicative of ambient air temperature;
a pressure sensor configured to provide signals indicative of ambient air pressure; and
a controller configured to:
receive signals indicative of the ambient air temperature and the ambient air pressure;
determine a desired engine inlet air temperature based on the signals indicative of the ambient air temperature and the ambient air pressure; and
control operation of the at least one aftercooler based on the desired engine air inlet temperature.

17. The locomotive of claim 16, further including:
a second temperature sensor configured to provide signals indicative of temperature at the engine air inlet; and
a second pressure sensor configured to provide signals indicative of pressure at the engine air inlet, wherein the controller is configured to determine the desired engine inlet air temperature based on a dew point temperature of the air at the engine air inlet based on the signals indicative of ambient air temperature and pressure and the signals indicative of temperature and pressure at the engine air inlet.

18. The locomotive of claim 16, wherein the at least one aftercooler includes an air-to-air aftercooler, and the controller is configured to control a flow of ambient air to the air-to-air aftercooler based on the desired engine inlet air temperature.

19. The locomotive of claim 16, wherein the at least one aftercooler includes an air-to-water aftercooler, and wherein the controller is configured to control a flow of coolant to the air-to-water aftercooler based on the desired engine inlet air temperature.

20. The locomotive of claim 16, further including an exhaust gas recirculation system configured to supply exhaust gas to the engine air inlet, wherein the controller is configured to control a flow of exhaust gas to the engine air inlet based on the desired engine inlet air temperature.
